(19) United States
(12) Patent Application Publication
(10) Pub. No.: US 2018/0299683 A1
(43) Pub. Date: Oct. 18, 2018

(54) IMAGE PRESENTING APPARATUS, OPTICAL TRANSMISSION TYPE HEAD-MOUNTED DISPLAY, AND IMAGE PRESENTING METHOD

(71) Applicant: SONY INTERACTIVE ENTERTAINMENT INC., Tokyo (JP)

(72) Inventors: Yoshinori OHASHI, Tokyo (JP); Yoichi NISHIMAKI, Kanagawa (JP)

(21) Appl. No.: 15/736,973

(22) PCT Filed: Jul. 14, 2016
(86) PCT No.: PCT/JP2016/070806

§ 371 Date: Dec. 15, 2017

(30) Foreign Application Priority Data
Jul. 21, 2015 (JP) 2015-144285

(51) Int. Cl. G02B 27/22; G02B 27/01

(52) U.S. Cl. CPC G02B 27/22; G02B 27/0172; G02B 2027/0174; G02B 2027/0178; G02B 2027/0134; G02B 27/0103

(57) ABSTRACT

A display portion 318 includes a plurality of display surfaces corresponding to a plurality of pixels within an image as a target of display, and the display surfaces are configured in such a way that positions thereof in a direction vertical to the display surfaces are made changeable. A convex lens 312 presents a virtual image of an image displayed on the display portion 318 to a field of vision of a user. A control portion 10 adjusts the positions of the plurality of display surfaces based on depth information on an object contained in the image as the target of the display, thereby adjusting a position of the virtual image presented by the convex lens 312 in units of a pixel.

### TECHNICAL FIELD

This invention relates to a data processing technique, and more particularly to an image presenting apparatus, an optical transmission type head-mounted display, and an image presenting method.

### BACKGROUND ART

In recent years, the development of the technique for presenting a stereoscopic image has progressed, and a Head-Mounted Display (hereinafter described as “an HMD”) which can present a stereoscopic image having a depth has become popular. Of such HMDs, a shielding type HMD exists which can perfectly cover and shield a field of vision of a user who mounts thereto an HMD to give a deep sense of immersion to the user who observes an image. In addition, an optical transmission type HMD has been developed as another kind of HMD. The optical transmission type HMD is an image presenting apparatus which can present a situation of an real space of the outside of the HMD to a user in a see-through style while it presents an Augmented Reality (AR) image as a virtual stereoscopic image to the user by using a holographic element, a half mirror, and the like.

### SUMMARY

### Technical Problem

For the purpose of reducing a visual sense of discomfort which is given to a user mounting the HMD to give a deeper sense of immersion to the user, it is required to increase a stereoscopic effect of a stereoscopic image which the HMD presents. In addition, when an AR image is presented by the optical transmission type HMD, the AR image is displayed so as to be superimposed on the real space. For this reason, when the stereoscopic object is especially presented in the form of an AR image, it is preferable for a user of the optical transmission type HMD to see an AR image in harmony with an object of the real space without a sense of discomfort. Thus, a technique for enhancing the stereoscopic effect of the AR image is desired.

The present invention has been made based on the recognition described above of the present invention, and a principal object thereof is to provide a technique for enhancing a stereoscopic effect of an image which an image presenting apparatus presents.

### Solution to Problem

In order to solve the problem described above, an image presenting apparatus according to a certain aspect of the present invention is provided with a display portion configured to display an image, and a control portion. The display portion includes a plurality of display surfaces corresponding to a plurality of pixels within an image as a target of display. Each of the display surfaces is configured to be changeable in position in a direction vertical to the display surface. The control portion adjusts positions of the plurality of display surfaces based on depth information on an object contained in the image as the target of the display.

Another aspect of the present invention is also an image presenting apparatus. This apparatus is provided with a display portion for displaying thereon an image, an optical element for presenting a virtual image of the image displayed on the display portion to a field of vision of a user, and a control portion. The display portion includes a plurality of display surfaces corresponding to a plurality of pixels within an image as a target of display. Each of the display surfaces is configured to be changeable in position in a direction vertical to the display surface. The control portion adjusts positions of the plurality of display surfaces based on depth information on an object contained in the image as the target of the display, thereby adjusting a position of a virtual image presented by the optical element in units of a pixel.

Still another aspect of the present invention is an image presenting method. This method is a method which an image presenting apparatus provided with a display portion carries out. The display portion includes a plurality of display surfaces corresponding to a plurality of pixels within an image as a target of display. Each of the display surfaces is configured to be changeable in position in a direction vertical to the display surface. The image presenting method includes a step of adjusting positions of the plurality of display surfaces based on depth information on an object contained in the image as the target of the display, and a step of causing the display portion in which the positions of the display surfaces are adjusted to display thereon the image as the target of the display.

Yet another aspect of the present invention is also an image presenting method. This method is a method which an image presenting apparatus provided with a display portion and an optical element carries out. The display portion includes a plurality of display surfaces corresponding to a plurality of pixels within an image as a target of display. Each of the display surfaces is configured to be changeable in position in a direction vertical to the display surface. The optical element presents a virtual image of the image displayed on the display portion to a field of vision of a user. The image presenting method includes a step of adjusting positions of the plurality of display surfaces based on depth information on an object contained in the image as the target of the display, and a step of causing the display portion in which the positions of the display surfaces are adjusted to display thereon the image as the target of the display, thereby presenting the virtual image of each of pixels within the image concerned to a position based on the depth information through the optical element.

It should be noted that constitutions which are obtained by converting an arbitrary combination of the constituent elements described above, and the expressions of the present invention among a system, a program, a recording medium in which the program is stored, and the like are also effective as aspects of the present invention.

### Advantageous Effect of Invention

According to the present invention, it is possible to enhance the stereoscopic effect of the image which the image presenting apparatus presents.

### BRIEF DESCRIPTION OF DRAWINGS

FIG. 1 is a view schematically depicting an external appearance of an image presenting apparatus of a first embodiment.

[FIG. 2]

(a) and (b) of FIG. 2 are perspective views each depicting a structure of a display portion.

FIG. 3 is a block diagram depicting a functional configuration of the image presenting apparatus of the first embodiment.

FIG. 4 is a flow chart depicting an operation of the image presenting apparatus of the first embodiment.

FIG. 5 is a view schematically depicting an external appearance of an image presenting apparatus of a second embodiment.

[FIG. 6]

(a) and (b) of FIG. 6 are views depicting a relationship between a virtual object in a three dimensional space, and the object concerned superimposed on a real space.

FIG. 7 is a view explaining a formula of a lens pertaining to a convex lens.

FIG. 8 is a view schematically depicting an optical system with which the image presenting apparatus of the second embodiment is provided.

FIG. 9 is a view depicting an image which a display portion is to display in order to present virtual images having the same size to different positions.

FIG. 10 is a block diagram depicting a functional configuration of the image presenting apparatus of the second embodiment.

FIG. 11 is a flow chart depicting an operation of the image presenting apparatus of the second embodiment.

FIG. 12 is a view schematically depicting an optical system with which an image presenting apparatus of a third embodiment is provided.

### DESCRIPTION OF EMBODIMENTS

Firstly, an outline will now be described. Light contains information on amplitude (intensity), a wavelength (color), and a direction (direction of ray of light). Although in a normal display, the amplitude and the wavelength of the light can be expressed, it is difficult to express the direction of ray of the light. For this reason, it was difficult that a person seeing the image on the display was caused to sufficiently perceive a depth of an object caught on the image concerned. The present inventor thought that if the information on the direction of ray of the light which the light has also be reproduced on the display, then, the person seeing the image on the display can be given the perception which is not different from the reality.

A system for drawing an image in a space by rotating a Light Emitting Diode (LED) array, and a system for realizing a multi-focus of a plurality of points of view by utilizing a micro-lens array exist as a system for reproducing a direction of ray of the light. However, the former involved a problem that the wear and the sound of a machine due to the rotation are generated and thus the reliability is low. In addition, the latter involved a problem that the resolution is reduced to (1/the number of points of view), and the load imposed on the drawing processing is high.

In the following first to third embodiments, a system for displacing (so to speak, making irregular) a surface of a display in a direction of a line of sight of the user every pixel is proposed as an improved system for reproducing the direction of the ray of the light. The direction of the line of sight of the user can be said as a Z-axis direction and can also be said as a depth direction.

Specifically, in the first embodiment, a plurality of display members forming a screen of a display, and corresponding to a plurality of pixels within an image becoming a target of display in the display is moved in a direction vertical to the screen of the display. According to this system, based on a two-dimensional image and depth information on an object contained in the two-dimensional image, the direction of the ray of the light emitted from the object within the image can be realistically reproduced, and a distance (depth) can be expressed every pixel. As a result, the image in which the stereoscopic effect is enhanced can be presented to a user.

In addition, in the second embodiment, there is presented a system for carrying out enlargement by using a lens so that the displacement for each pixel has to be small. Specifically, a virtual image of an image which is displayed on a display through an optical element is presented to a user, and a distance to the virtual image which the user is caused to be perceived is changed every pixel. According to this system, the image in which the stereoscopic effect is more enhanced can be presented to the user. Furthermore, in the third embodiment, there is depicted an example in which projection mapping is carried out for a surface which is dynamically displaced. Although described later, an HMD is depicted as a suitable example of the second and third embodiments.

### First Embodiment

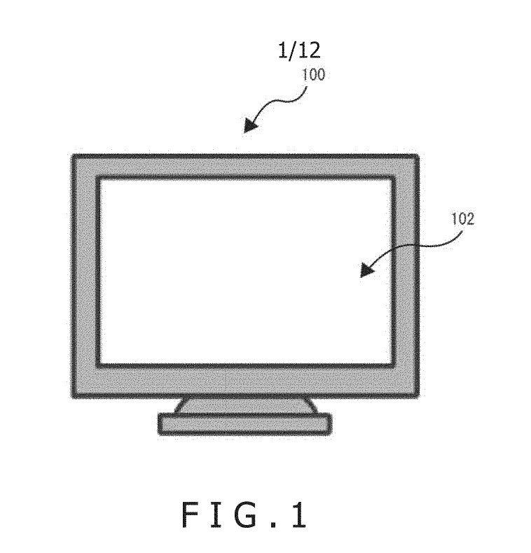

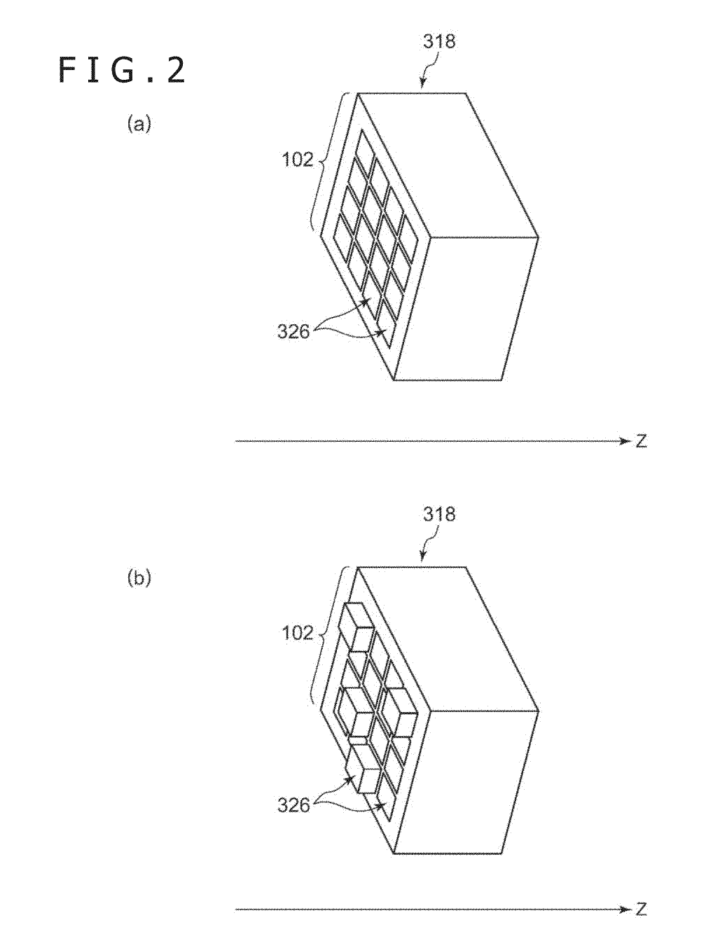

FIG. 1 schematically depicts an external appearance of an image presenting apparatus 100 of a first embodiment. The image presenting apparatus 100 of the first embodiment is a display apparatus provided with a screen 102 for actively and autonomously displaying thereon an image. For example, the image presenting apparatus 100 may be an LED display or an Organic Light Emitting Diode (OLED) display. In addition, the image presenting apparatus 100 may be a display apparatus having a relatively large size of several tens of inches (for example, a television receiver or the like).

(a) and (b) of FIG. 2 are perspective views each depicting a configuration of a display portion. A display portion 318 constitutes a screen 102 of the image presenting apparatus 100. In FIG. 2, a horizontal direction is set as a Z-axis, that is, a left side surface of the display portion 318 in FIG. 2 corresponds to the screen 102 of the image presenting apparatus 100. The display portion 318 includes a plurality of display surfaces 326 in an area (in the left side surface in FIG. 2) constituting the screen 102. The area constituting the screen 102 is typically a surface confronting a user seeing the image presenting apparatus 100, in other words, a surface orthogonally intersecting a line of sight of the user. The plurality of display surfaces 326 corresponds to a plurality of pixels within an image becoming a target of display. In other words, the plurality of display surfaces 326 corresponds to a plurality of pixels in the screen 102 of the image presenting apparatus 100.

In the first embodiment, the pixels within the image displayed on the display portion 318 (the screen 102), in other words, the pixels of the screen 102, and the display surfaces 326 shall present one-to-one correspondence. That is to say, the display surfaces 326 for the number of pixels for the image to be displayed are provided in the display portion 318 (the screen 102). In other words, the display surfaces 326 for the number of pixels of the screen 102 are provided in the display portion 318. Although in (a) and (b) of FIG. 2, for convenience, 16 display surfaces are depicted, actually, a large number of fine display surfaces 326 are provided. For example, (1,440×1,080) display surfaces 326 may be provided.

In each of the plurality of display surfaces 326, a position in a direction vertical to the screen 102 (display surface) is configured to be changeable. The direction vertical to the display surface can also be said as the Z-axis direction, that is, the direction of the line of sight of the user. Here, FIG. 2(a) depicts a state in which the positions of all the display surfaces 326 are set to a reference position (initial position). FIG. 2(b) depicts a state in which the positions of a part of the display surfaces 326 are projected forward with respect to the reference position. In other words, FIG. 2(b) depicts a state in which the positions of a part of the display surfaces 326 are made close to the side of a point of view of the user.

The display portion 318 of the first embodiment includes a Micro Electro Mechanical Systems (MEMS). In the display portion 318, the plurality of display surfaces 326 is driven independently of one another by a micro-actuator of the MEMS, and thus the positions, in the Z-axis direction, of the display surfaces 326 are set independently of one another. The position control for the plurality of display surfaces 326 may also be realized by a combination of a technique for controlling Braille dots in a Braille display or a Braille printer, and the MEMS. In addition, the position control for the plurality of display surfaces 326 may also be realized by a combination of a technique for controlling a state of minute projections (projection and burying) in a tactile display, and the MEMS. The display surfaces 326 corresponding to the individual pixels include light emitting elements of the three primary colors, and are driven independently of one another by the micro-actuator.

In the first embodiment, as depicted in FIG. 2(b), since the positions of the display surfaces 326 are projected forward with respect to the reference position, thereby adjusting the positions of the display surfaces 326, a piezoelectric actuator is used as the micro-actuator. As a modified change, the positions of the display surfaces 326 may be moved backward with respect to the reference position (adjusted so as to be apart from the point of view of the user), thereby adjusting the positions of the display surfaces 326. In this case, an electrostatic actuator may be used as the micro-actuator. Although the piezoelectric actuator or the electrostatic actuator has a merit suitable for the miniaturization, an electromagnetic actuator or a thermal actuator may also be used as other aspects.

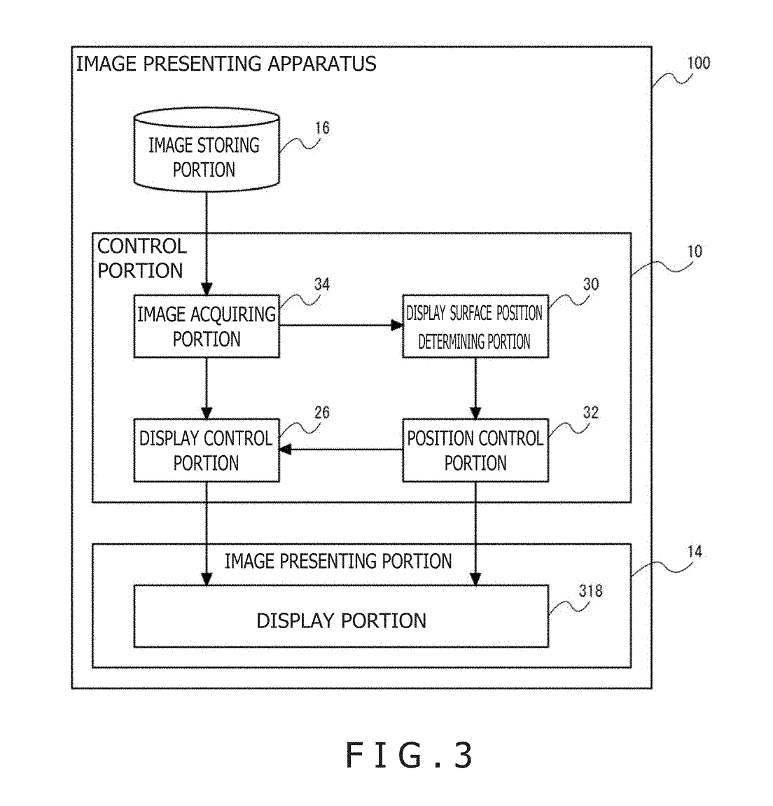

FIG. 3 is a block diagram depicting a functional configuration of the image presenting apparatus 100 of the first embodiment. Blocks depicted in block diagrams of this description are realized by various kinds of modules which are mounted in a chassis of the image presenting apparatus 100. For example, in terms of hardware, the blocks can be realized by elements, including a Central Processing Unit (CPU) and a memory, and electronic circuits of a computer, and mechanical apparatuses and in terms of software, the blocks are realized by a computer program and the like. In this case, however, functional blocks which are realized by cooperation with those are drawn. Therefore, it is understood by a person skilled in the art that these functional blocks can be realized in the various forms by a combination of the hardware and the software.

For example, a computer program including the modules corresponding to the blocks of the control portion 10 of FIG. 3 may be stored in a recording medium such as a Digital Versatile Disk (DVD) to be circulated, or may be down-loaded from a predetermined sever to be installed in the image presenting apparatus 100. In addition, a CPU or a Graphics Processing Unit (GPU) of the image presenting apparatus 100 may read out the computer program thereof to a main memory to execute the computer program thereof, thereby exerting the functions of the control portion 10 of FIG. 3.

The image presenting apparatus 100 is provided with the control portion 10, an image presenting portion 14, and an image storing portion 16. The image storing portion 16 is a storage area in which data on the image such as a still image or a moving image (image) to be presented to the user is stored. The image storing portion 16 may be realized by the various kinds of recording media such a DVD, or a storage device such as a Hard Disk Drive (HDD). The image storing portion 16 further stores therein depth information on various kinds of objects such as a human being, a building, a background, a landscape which are caught on the image.

The depth information is information that when for example, an image on which a certain subject is caught is presented to a user, a sense of distance which is recognized by looking at the subject by the user is reflected on the user. For this reason, an example of the depth information of the object includes distances from a camera to the objects when a plurality of objects is imaged. In addition, the depth information of the object may be information exhibiting a distance from an absolute position in the depth direction for portions (for example, portions corresponding to the respective pixels) of the object, for example, a predetermined reference position (the origin or the like). In addition, the depth information may be information exhibiting a relative position between the portions of the object, for example, a difference in coordinates, or may also be information exhibiting front and behind of the position (long and short of a distance from a point of view).

In the first embodiment, the depth information shall be determined in advance every image in units of a frame, and shall be stored in the image storing portion 16 with the image in units of a frame and the depth information being made to correspond to each other in combination. As a modified change, the image becoming a target of display, and the depth information may be presented to the image presenting apparatus 100 through a broadcasting wave or the Internet. In addition, the control portion 10 of the image presenting apparatus 100 may be further provided with a depth information producing portion for analyzing an image which is statically held or dynamically presented, thereby producing depth information on objects contained in the image.

The image presenting portion 14 causes an image stored in the image storing portion 16 to be displayed on the screen 102. The image presenting portion 14 includes a display portion 318. The control portion 10 executes data processing for presenting an image to a user. Specifically, the control portion 10 adjusts positions, in the Z-axis direction, of the plurality of display surfaces 326 in the display portion 318 in units of pixels within an image as a target of presentation based on the depth information on the object(s) caught on the image as the target of the presentation. The control portion 10 includes an image acquiring portion 34, a display surface position determining portion 30, a position control portion 32, and a display control portion 26.

The image acquiring portion 34 reads image data which is stored in the image storing portion 16 at a predetermined rate (a refresh rate of the screen 102, or the like) and the depth information which is made to correspond to the image data. The image acquiring portion 34 outputs the image data to the display control portion 26, and outputs the depth information to the display surface position determining portion 30. As has been described above, when the image data and the depth information are presented through the broadcasting wave or the Internet, the image acquiring portion 34 may acquire the image data and the depth information through an antenna or a network adapter (not depicted).

The display surface position determining portion 30 determines the positions of the plurality of display surfaces 326 which the display portion 318 includes, specifically, the positions in the Z-axis direction based on the depth information on the objects contained in the image as the target of the display. In other words, the display surface position determining portion 30 determines the positions of the display surfaces 326 corresponding to the pixels in the partial areas of the image as the target of the display. Here, the positions in the Z-axis direction may be a displacement amount (movement amount) from the reference position.

Specifically, the display surface position determining portion 30 determines the positions of the display surfaces 326 in such a way that a position of the display surface 326 corresponding to a first pixel is located more forward than the position of the display surface 326 corresponding to a second pixel with respect to the first pixel and the second pixel. In this case, the first pixel corresponds to a portion in the real space or the virtual space to which a distance from a camera into the real space or the virtual space is close. The second pixel corresponds to a portion of the object from which the distance from the camera is far. The forward or front means a user side in the Z-axis direction, typically, a side of a point 308 of view of a user confronting the image presenting apparatus 100.

In addition, the display surface position determining portion 30 determines the positions of the display surfaces 326 in such a way that in the pixel corresponding to a portion of the object located further relatively forward, the position of the display surface 326 corresponding to that pixel is located relatively forward. In other words, the display surface position determining portion 30 determines the positions of the display surfaces 326 in such a way that in the pixel corresponding to a portion of the object located further relatively backward, the position of the display surface 326 corresponding to that pixel is located relatively backward. The display surface position determining portion 30 may output the information exhibiting a distance from the predetermined reference position (initial position), or the information exhibiting a movement amount as the information on the positions of the individual display surfaces 326.

The position control portion 32 carries out the control in such a way that the positions, in the Z-axis direction, of the plurality of display surfaces 326 on the display portion 318 become the positions determined by the display surface position determining portion 30. For example, the position control portion 32 outputs a signal in accordance with which the display surfaces 326 of the display portion 318 are operated, that is, a predetermined signal in accordance with which the MEMS actuator for driving the display surfaces 326 is controlled to the display portion 318. The information exhibiting the positions, in the Z-axis direction, of the display surfaces 326 which are determined by the display surface position determining portion 30 is contained in this signal. For example, the information exhibiting the displacement amount (movement amount) from the reference position is contained in this signal.

The display portion 318 changes the positions, in the Z-axis direction, of the individual display surfaces 326 based on the signal transmitted thereto from the position control portion 32. For example, the display portion 318 moves the individual display surfaces 326 from either the initial position or the positions until that time to positions specified by the signal by controlling a plurality of actuators for driving the plurality of display surfaces 326.

The display control portion 26 outputs the image data outputted thereto from the image acquiring portion 34 to the display portion 318, thereby causing the image containing the various objects to be displayed on the display portion 318. For example, the display control portion 26 outputs the individual pixel values constituting the image to the display portion 318. Then, the display portion 318 causes the individual display surfaces 326 to emit light in the forms corresponding to the individual pixel values. It should be noted that either the image acquiring portion 34 or the display control portion 26 may suitably execute other pieces of processing, necessary for display of the image, such as decoding processing.

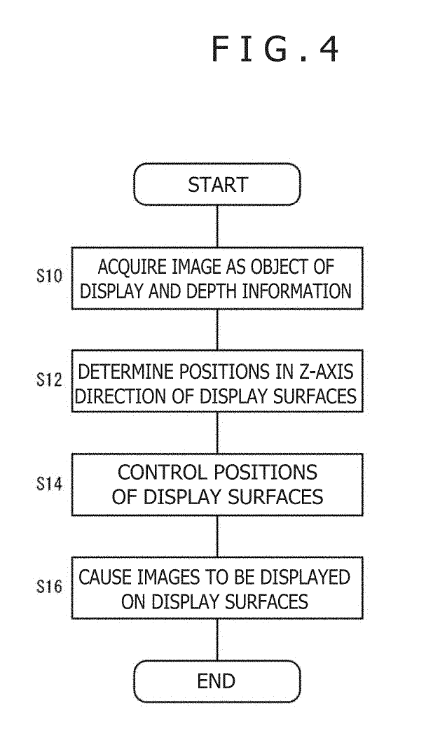

A description will now be given with respect to an operation of the image presenting apparatus 100 configured in the manner described above. FIG. 4 is a flow chart depicting an operation of the image presenting apparatus 100 of the first embodiment. Processing depicted in the figure may be started when a user manipulation to instruct to display the image stored in the image storing portion 16 is inputted to the image presenting apparatus 100. In addition, when the image or the depth information is dynamically presented, processing depicted in the figure may be started when a program (channel) is selected by the user, and the selected program is displayed. It should be noted that the image presenting apparatus 100 repeats pieces of processing from S10 to S18 in response to a predetermined refresh rate (for example, 120 Hz).

The image acquiring portion 34 acquires the image becoming the target of the display, and the depth information corresponding to that image from the image storing portion 16 (S10). The display surface position determining portion 30 determines the positions, on the Z-axis, of the display surfaces 326 corresponding to the pixels within the image as the target of the display in accordance with the depth information acquired from the image acquiring portion 34 (S12). The position control portion 32 adjusts the positions, in the Z-axis direction, of the display surfaces 326 in the display portion 318 in accordance with the determination by the display surface position determining portion 30 (S14). When the adjustment of the positions of the display surfaces 326 has been completed, the position control portion 32 instructs the display control portion 26 to carry out the display. Then, the display control portion 26 causes the display portion 318 to display the image produced by the image acquiring portion 34 (S16).

According to the image presenting apparatus 100 of the first embodiment, of a plurality of portions within the image as the target of the display, a portion close to the camera in either the real space or the virtual space can be displayed in a position which is relatively close to the user. In addition, a portion far from the camera can be displayed in a position which is relatively far from the user. As a result, the objects (and portions of the objects) within the image can be presented in a form of reflecting thereon the information on the depth direction, and the reproducibility of the depth in either the real space or the virtual space can be enhanced. In other words, the reproducibility of the information on the direction of the ray of light which the light has can be enhanced. As a result, the display can be realized which presents the image having the improved stereoscopic effect. In addition, even in the case of the single eye, the user seeing the image can be made to inspire the stereoscopic effect.

### Second Embodiment

An image presenting apparatus 100 of a second embodiment is an HMD to which a device (the display portion 318) which is displaced in the Z-axis direction is applied. By enlarging the image to be presented to the user by using a lens, the stereoscopic effect of the image can be further enhanced while the displacement amounts of the display surfaces 326 are suppressed. Hereinafter, the same reference numerals are designated to the same or corresponding members as or to those described in the first embodiment. The description which duplicates that of the first embodiment is suitably omitted.

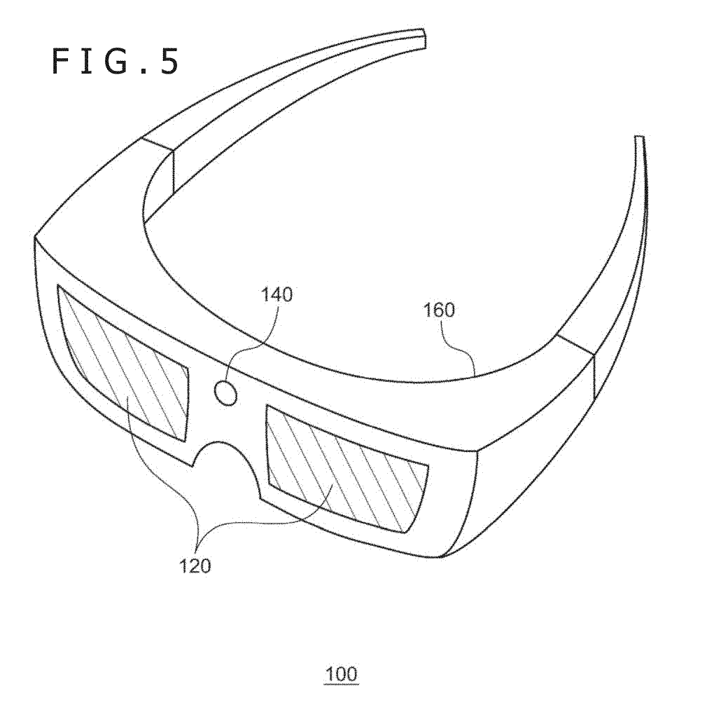

FIG. 5 schematically depicts an external appearance of the image presenting apparatus 100 of the second embodiment. The image presenting apparatus 100 includes a presentation portion 120, an image pickup element 140, and a chassis 160 for accommodating therein various modules. The image presenting apparatus 100 of the second embodiment is an optical transmission type HMD for displaying an AR image so as to be superimposed on the real space. However, the image presenting technique in the second embodiment can also be applied to a shielding type HMD. For example, the image presenting technique in the second embodiment can also be applied to the case where the similar various kinds of image contents to those of the first embodiment are displayed. In addition, the image presenting technique in the second embodiment can also be applied to the case where a Virtual Reality (VR) image is displayed, or the case where like the 3D motion picture, the stereoscopic image containing a parallax image for a left eye, and a parallax image for a right eye is displayed.

The presentation portion 120 presents the stereoscopic image to the eyes of the user. The presentation portion 120 may also individually present the parallax image for the left eye, and the parallax image for the right eye to the eyes of the user. The image pickup element 140 images a subject existing in the area containing a field of vision of the user mounting thereto the image presenting apparatus 100. For this reason, when the user mounts thereto the image presenting apparatus 100, the image pickup element 140 is disposed on the chassis 160 so as to be located in the vicinity of the eye brows of the user. The image pickup element 140 can be realized by using the known solid-state image pickup element such as a Charge Coupled Device (CCD) or the Complementary Metal Oxide Semiconductor (CMOS).

The chassis 160 plays a role of a frame in the image presenting apparatus 100, and accommodates therein the various modules (not depicted) which the image presenting apparatus 100 utilizes. The image presenting apparatus 100 may include an optical parts or components including a hologram light-guide plate, a motor for changing positions of these optical parts or components, communication modules such as other Wireless Fidelity (Wi-Fi, registered trademark) module, and modules such as an electronic compass, an acceleration sensor, a tilt sensor, a Global Positioning System (GPS) sensor, and an illuminance sensor. In addition, the image presenting apparatus 100 may also include a processor (such as a CPU or a GPU) for controlling these modules, a memory becoming an operation area of the processor, and the like. These modules are exemplifications, and thus the image presenting apparatus 100 does not necessarily need to equip with all these modules. It is only necessary that which of modules is equipped with is determined depending on a utilization scene which is supposed in the image presenting apparatus 100.

FIG. 5 depicts a spectacle type HMD as an example of the image presenting apparatus 100. As far as a shape of the image presenting apparatus 100, there are thought various variations such as a cap shape, a belt shape fixed by making around the head portion of a user, and a helmet shape which covers the entire head portion of a user in addition to the spectacle type shape. However, it is readily understood by a person skilled in the art that the image presenting apparatus 100 having any of these shapes is also included in the second embodiment of the present invention.

Next, a description will be given with respect to the principle of enhancing the stereoscopic effect of the image which the image presenting apparatus 100 of the second embodiment presents with reference to FIG. 6 to FIG. 9.

(a) and (b) of FIG. 6 schematically depict a relationship between an object in the virtual three-dimensional space, and the object concerned which is superimposed on the real space. FIG. 6(a) depicts a situation in which a virtual camera 300 as a virtual camera set in the virtual three-dimensional space (hereinafter referred to as “the virtual space”) photographs a virtual object 304 as a virtual object. The virtual three-dimensional orthogonal coordinate system (hereinafter referred to as “the virtual coordinate system 302”) for regulating the position coordinates of the virtual object 304 is set in the virtual space.

The virtual camera 300 is a virtual binocular camera. The virtual camera 300 produces the parallax image for the left eye and the parallax image for the right eye of the user. An image of the virtual object 304 which is photographed by the virtual camera 300 in the virtual space is changed depending on a distance from the virtual camera 300 in the virtual space to the virtual object 304. The virtual object 304 contains various things which an application such as a game presents to the user, for example, contains a human being (a character or the like), a building, a background, a landscape, and the like which exist in the virtual space.

FIG. 6(b) depicts a situation in which the image of the virtual object 304 in the case where that image is seen from the virtual camera 300 in the virtual space is displayed so as to be superimposed on the real space. In FIG. 6(b), a disk 310 is a real disk existing in the real space. When the user mounting thereto the image presenting apparatus 100 observes the disk 310 with a left eye 308a and a right eye 308b, the user observes the disk 310 as if the virtual object 304 is placed on the disk 310. In such a way, the image which is displayed so as to be superimposed on the real thing existing in the real space is the AR image. Hereinafter, in this description, when the left eye 308a and the right eye 308b of the user are not especially distinguished from each other, they are simply described as “a point 308 of view.”

Similarly to the virtual space, the three-dimensional orthogonal coordinate system (hereinafter referred to as “the real coordinate system 306”) for regulating the position coordinates of the virtual object 304 is set in the real space as well. The image presenting apparatus 100 changes the presented position of the virtual object 304 in the real space depending on a distance from the virtual camera 300 in the virtual space to the virtual object 304 in the virtual space by referring to the virtual coordinate system 302 and the real coordinate system 306. More specifically, the image presenting apparatus 100 changes the presented position of the virtual object 304 in the real space in such a way that as the distance from the virtual camera 300 in the virtual space to the virtual object 304 in the virtual space is longer, the virtual image of the virtual object 304 is disposed in the position far from the point 308 of view in the real space.

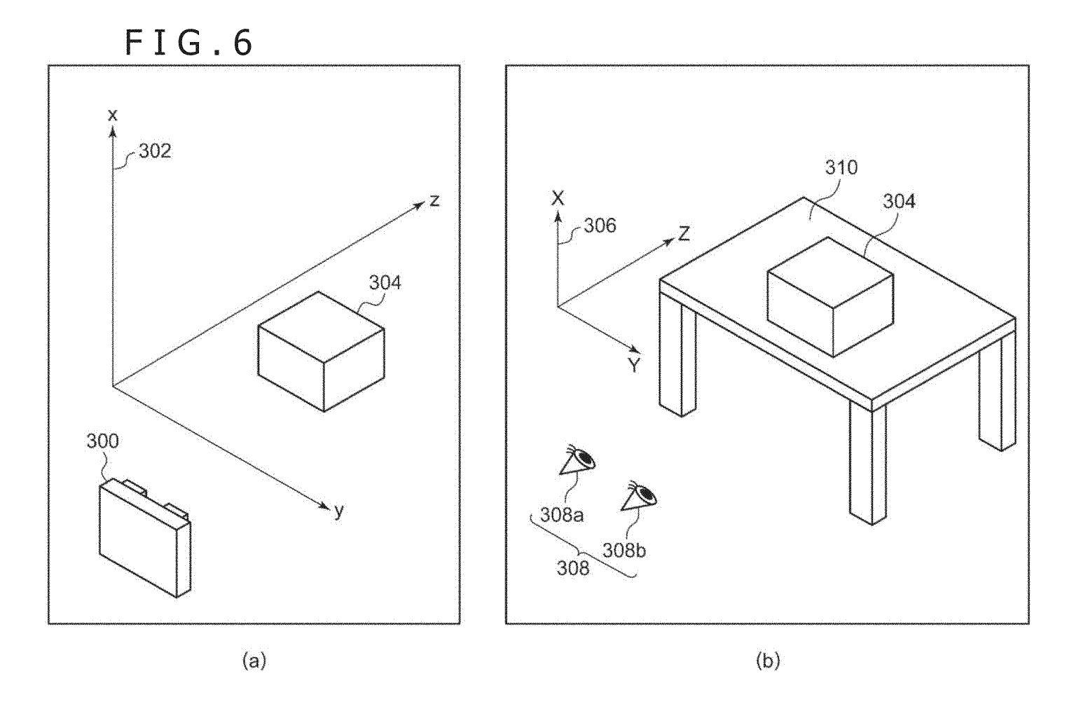

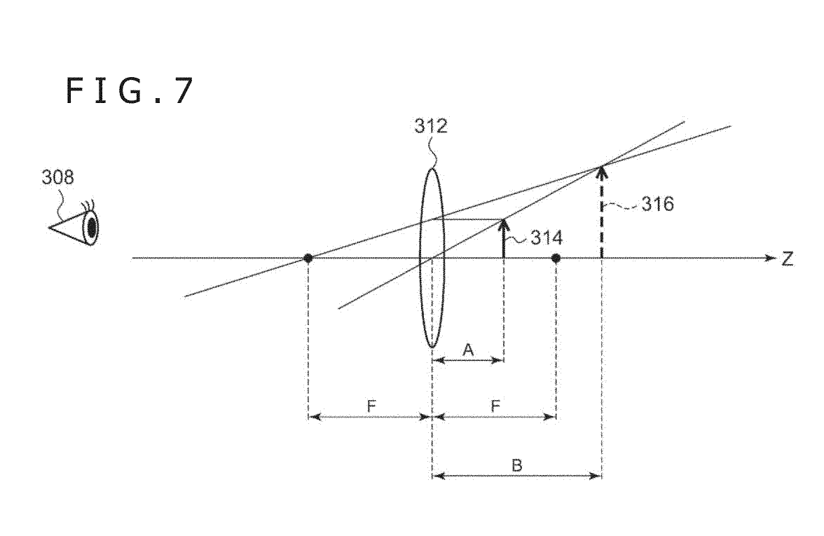

FIG. 7 is a view explaining a formula of a lens pertaining to a convex lens. More specifically, FIG. 7 is a view explaining a relationship between an object 314 and a virtual image 316 thereof in the case where the object is present inside a focal point of the convex lens 312. As depicted in FIG. 7, the Z-axis is decided in the direction of the line of sight of the point 308 of view, and the convex lens 312 is disposed in such a way that an optical axis of the convex lens 312 and the Z-axis agrees with each other on the Z-axis. The focal length of the convex lens 312 is F, and the object 314 is disposed at a distance A (A<F) from the convex lens 312 on a side opposite to the point 308 of view with respect to the convex lens 312. That is to say, in FIG. 7, the object 314 is disposed inside the focal point of the convex lens 312. At this time, when the object 314 is viewed from the point 308 of view, the object 314 is observed as a virtual image 316 in a position which is at a distance B (F<B) from the convex lens 312.

At this time, a relationship among the distance A, the distance B, and the focal length F is regulated by the known formula of a lens indicated in following Expression (1).

1/A−1/B=1/F Expression (1)

In addition, a ratio of a size Q (a length of an arrow of a broken line in FIG. 7) of the virtual image 316 to a size P (a length of an arrow of a solid line in FIG. 7) of the object 314, that is, amplitude m=Q/P is expressed by following Expression (2).

m=B/A Expression (2)

Expression (1) can also be grasped as indicating a relationship, which the distance A of the object 314 and the focal length F should meet, for presenting the virtual image 316 to the position which is at the distance B from the convex lens 312 on the side opposite to the point 308 of view with respect to the convex lens 312. For example, let us consider the case where the focal length F of the convex lens 312 is fixed. In this case, Expression (1) s deformed to be enabled to be expressed as following formula (3) with the distance A as a function of the distance B.

A(B)=FB/(F+B)=F/(1+F/B) Expression (3)

Expression (3) indicates a position where the object 314 should be disposed in order to present the virtual image 316 to the position of the distance B when the focal length of the convex lens is F. As apparent from Expression (3), as the distance B becomes larger, the distance A also becomes large.

In addition, when Expression (1) is substituted for Expression (2) to deform Expression (2), the size P which the object 314 should take in order to present the virtual image 316 having a size Q to the position of the distance B can be expressed as indicated in following Expression (4).

P(B,Q)=Q×F/(B+F) Expression (4)

Expression (4) is Expression which expresses the size P which the subject 314 should take as a function of the distance B and the size Q of the virtual image 316. Expression (4) indicates that as the size Q of the virtual image 316 is larger, the size P of the object 314 becomes large. In addition, Expression (4) also indicates that as the distance B of the virtual image 316 is larger, the size P of the object 314 becomes small.

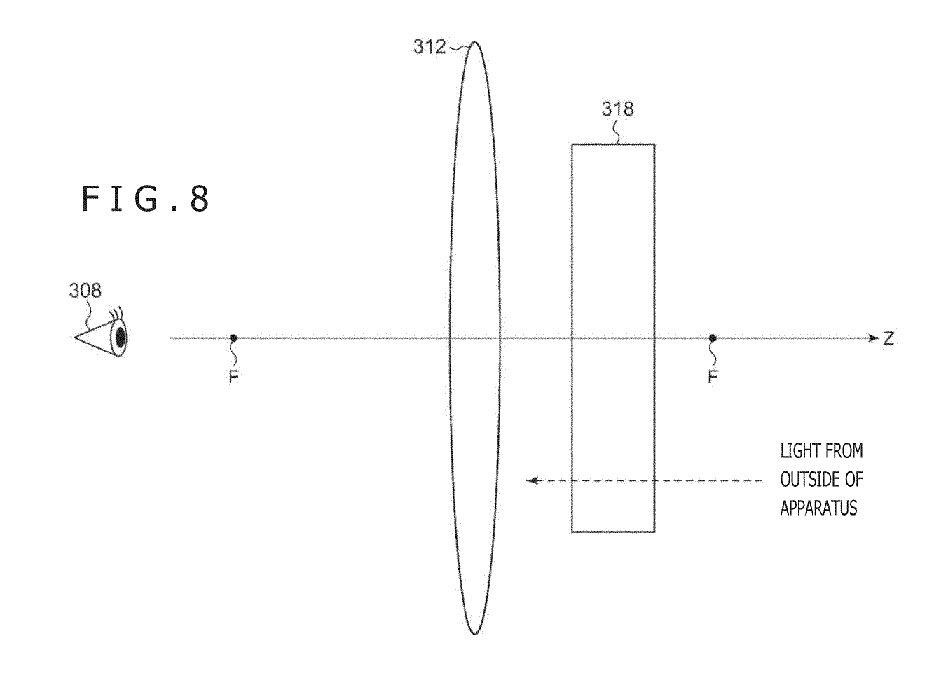

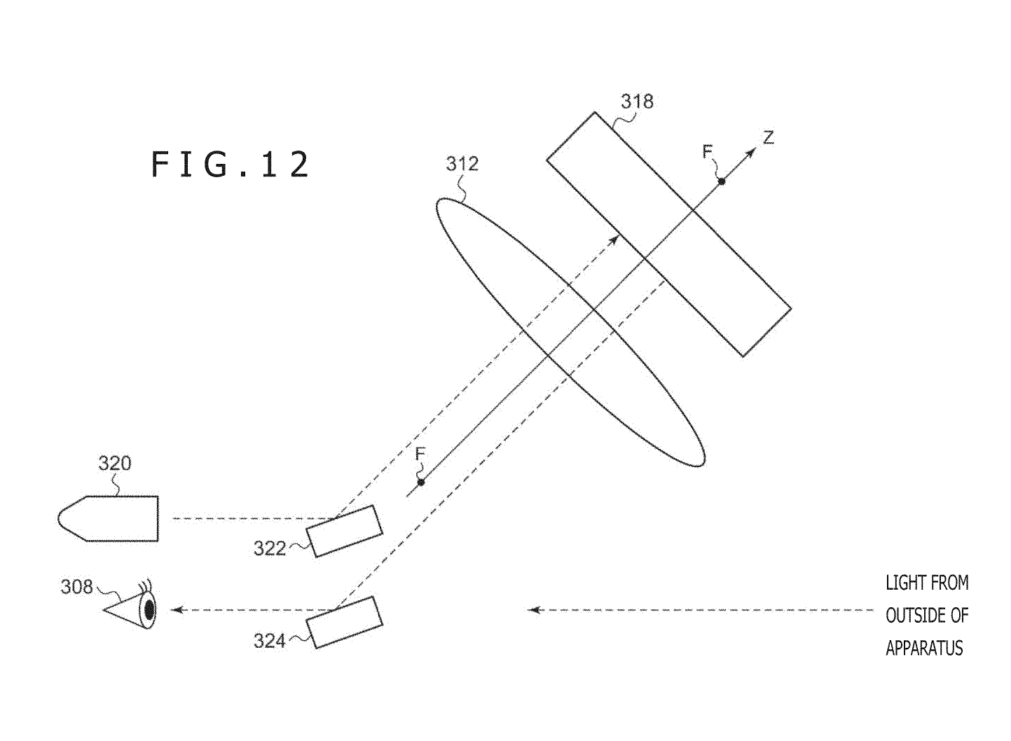

FIG. 8 schematically depicts an optical system with which the image presenting apparatus 100 of the second embodiment is provided. The image presenting apparatus 100 is provided with the convex lens 312 and the display portion 318 within the chassis 160. The display portion 318 depicted in the figure is a transmission type OLED display which transmits the visible light from the outside of the apparatus while it displays the image (AR image) on which the various kinds of objects are caught. When a non-transmission type display is used as the display portion 318, a configuration depicted in FIG. 12 which will be described later may be adopted.

In FIG. 8, the Z-axis is decided in the direction of the line of sight of the point 308 of view. Thus, the convex lens 312 is disposed in such a way that the optical axis of the convex lens 312 and the Z-axis agree with each other on the Z-axis. A focal length of the convex lens 312 is F, and in FIG. 8, two points F represent the focal points of the convex lens 312. As depicted in FIG. 8, the display portion 318 is disposed inside the focal point of the convex lens 312 on a side opposite to the point 308 of view with respect to the convex lens 312.

In such a way, the convex lens 312 is present between the point 308 of view and the display portion 318. Therefore, when the display portion 318 is viewed from the point 308 of view, the image which the display portion 318 displays is observed as the virtual image complying with Expression (1) and Expression (2). In this sense, the convex lens 312 functions as an optical element for producing the virtual image of the image which the display portion 318 displays thereon. In addition, as depicted in Expression (3), the positions, in the Z-axis direction, of the display surfaces 326 of the display portion 318 are changed, thereby resulting in that the virtual image of the image (pixels) depicted on the display surfaces 326 shall be observed in different position(s).

In addition, the image presenting apparatus 100 is an optical transmission type HMD for transparently bringing the visible light from the outside (in the front of the user) of the apparatus to the eyes of the user via the presentation portion 120 in FIG. 5. Therefore, the eyes of the user observe a state in which the situation (for example, the object in the real space) of the real space of the outside of the apparatus, and the virtual image (for example, the virtual image of the virtual object 304) of the image which the display portion 318 displays are superimposed on each other.

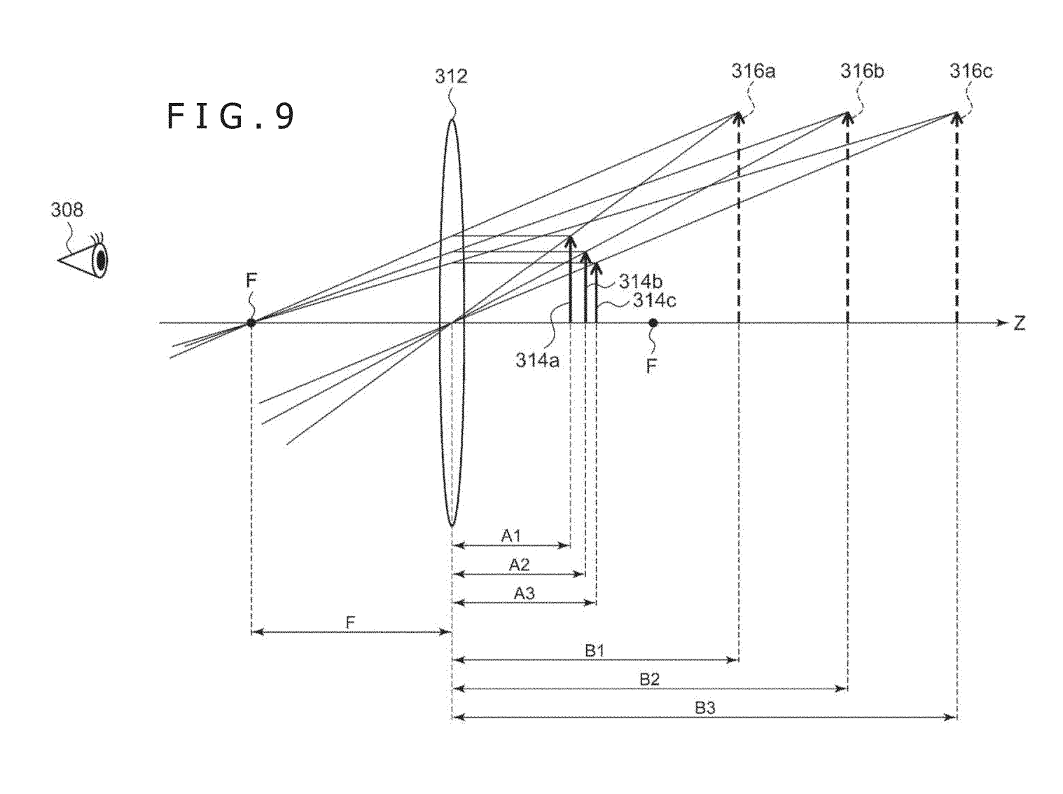

FIG. 9 depicts an image which the display portion 318 should display in order to present the virtual images having the same size to different positions. FIG. 9 depicts an example in the case where three virtual images 316a, 316b, and 316c are presented to positions which are at distances B1, B2, and B3 from the optical center of the convex lens 312, respectively, so as to have the same size Q. In addition, in FIG. 9, images 314a, 314b, and 314c are images corresponding to the virtual images 316a, 316b, and 316c, respectively. The images 314a, 314b, and 314c are displayed by the display portion 318. Incidentally, with regard to the formula of the lens depicted in Expression (1), the object 314 in FIG. 7 corresponds to the image which the display portion 318 displays in FIG. 9. From this reason, similarly to the case of the object 314 in FIG. 7, the image in FIG. 9 is also assigned the reference numeral 314.

More specifically, the images 314a, 314b, and 314c are displayed by the display surfaces 326 located in positions which are at distances A1, A2, and A3 from the optical center of the convex lens 312, respectively. Here, A1, A2, and A3 are given from Expression (3) by the following expressions, respectively:

A1=F/(1+F/B1);

A2=F/(1+F/B2); and

A3=F/(1+F/B3).

In addition, the sizes P1, P2, and P3 of the images 314a, 314b, and 314c to be displayed are given from Expression (4) by the following expressions using the size Q of the virtual image 316:

P1=Q×F/(B1+F);

P2=Q×F/(B2+F); and

P3=Q×F/(B3+F).

In such a way, the display position of the image 314 in the display portion 318 is changed, in other words, the positions, in the Z-axis direction, of the display surfaces 326 on which the image is to be displayed are changed, thereby enabling the position of the virtual image 316 which is presented to the user to be changed. In addition, the sizes of the images displayed on the display portion 318 are changed, thereby enabling the sizes of the virtual image 316 to be presented to also be controlled.

It should be noted that the configuration of the optical system depicted in FIG. 8 is an example, and thus the virtual images of the images which are displayed on the display portion 318 may be presented to the user through optical systems having different configurations. For example, an aspherical lens, a prism or the like may be used as the optical element for presenting the virtual image. This also applies to an optical system in a third embodiment which will be described later in conjunction with FIG. 12. As the optical element for presenting the virtual image, an optical element having a short focal length (for example, approximately a few millimeters) is desirable. The reason for this is because the displacement amount of the display surface 326, in other words, the necessary movement distance in the Z-axis direction can be shortened, and thus the compactification and the power saving of the HMD are easy to realize.

The description has been given so far with respect to the relationship between the position of the object 314 and the position of the virtual image 316, and the relationship between the size of the object 314, and the size of the virtual image 316 in the case where the object 314 is located inside the focal point F of the convex lens 312. Subsequently, a description will be given with respect to a functional configuration of the image presenting apparatus 100 of the second embodiment. The image presenting apparatus 100 of the second embodiment utilizes the relationship between the image 314 and virtual image 316 described above.

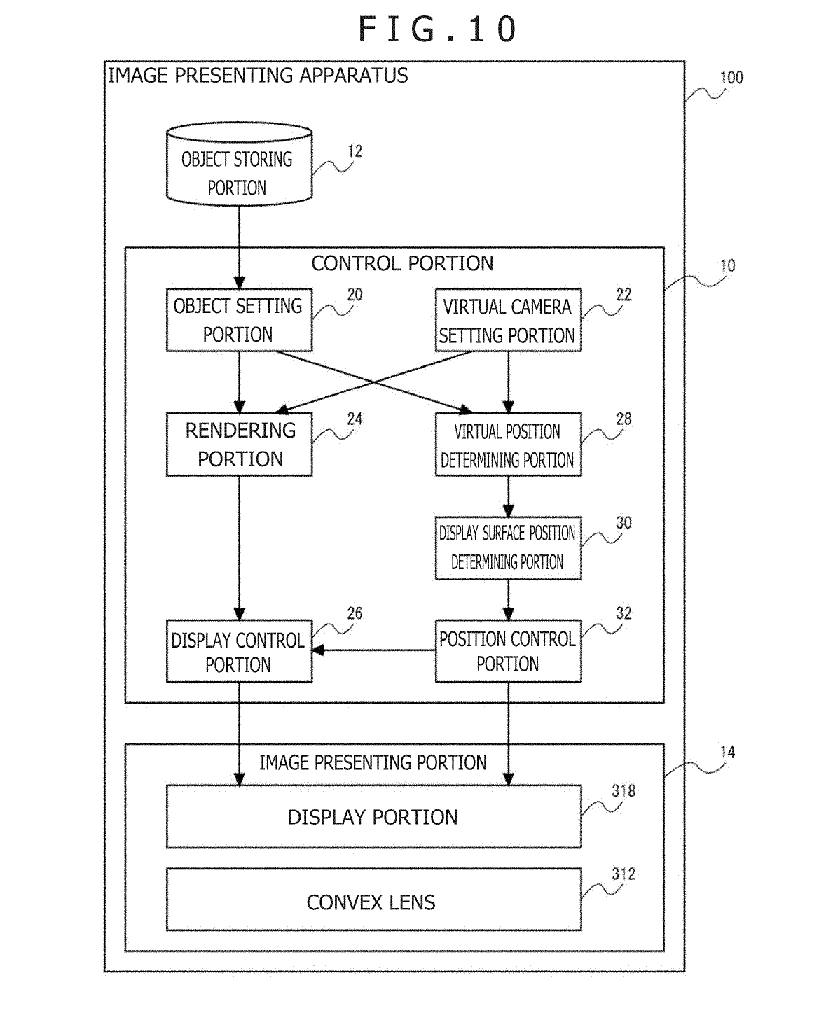

FIG. 10 is a block diagram depicting the functional configuration of the image presenting apparatus 100 of the second embodiment. The image presenting apparatus 100 is provided with a control portion 10, an object storing portion 12, an image presenting portion 14. The control portion 10 executes various kinds of data processing for presenting an AR image to a user. The image presenting portion 14 presents an image (AR image) which is subjected to the rendering by the control portion 10 to the user mounting thereto the image presenting apparatus 100 so as for the image (AR image) to be superimposed on the real space which the user observes. Specifically, a virtual image 316 of the image containing the virtual object 304 is presented so as to be superimposed on the real space. The control portion 10 adjusts the position where the image presenting portion 14 presents the virtual image 316 based on the depth information on the virtual object 304 which is caught on the image presented to the user.

As described above, the depth information is information which reflects the sense of distance recognized by the user who sees the object when, for example, the image on which a certain subject is caught is presented to the user. For this reason, the depth information contains the distance from the virtual camera 300 to the virtual object 304 when the virtual object 304 is photographed as an example of the depth information on the virtual object 304. In addition, the depth information on the virtual object 304 may be information exhibiting the absolute position or the relative position in the depth direction of portions (for example, portions corresponding to the pixels) of the virtual object 304.

When the distance from the virtual camera 300 to the virtual object 304 in the virtual space is short, the control portion 10 controls the image presenting portion 14 in such a way that the virtual image 316 of the image of the virtual object 304 is presented to the position which is short when viewed from the user as compared with the case where the distance from the virtual camera 300 to the virtual object 304 in the virtual space is long. Although the details will be described later, the control portion 10 adjusts the positions of the plurality of display surfaces 326 based on the depth information on the virtual object 304 contained in the image as a target of display, thereby adjusting the presentation position of the virtual image 316 through the convex lens 312 in units of a pixel.

In addition, the control portion 10 carries out the adjustment in such a way that the distance between the display surface 326 corresponding to a first pixel and the convex lens 312 is made shorter than the distance between the display surface 326 corresponding to a second pixel and the convex lens 312 with respect to the first pixel and the second pixel. In this case, the first pixel corresponds to a portion of the virtual object 304 to which the distance from the virtual camera 300 is close. The second pixel corresponds to a portion of the virtual object 304 from which the distance from the virtual camera 300 is far. In addition, the control portion 10 adjusts the position of the display surface 326 corresponding to at least one of the first pixel and the second pixel in such a way that the virtual image 316 of the first pixel is presented more forward than the virtual image 316 of the second pixel.

The image presenting portion 14 includes a display portion 318 and a convex lens 312. The display portion 318 of the second embodiment is also a display for actively, autonomously displaying thereon the image similarly to the case of the first embodiment. For example, the display portion 318 is a light emitting diode (LED) display or an organic light emitting diode (OLED) display. In addition, the display portion 318 includes the plurality of display surfaces 326 corresponding to a plurality of pixels within the image. Since in the second embodiment, the virtual image obtained by enlarging the displayed image is presented to the user, the display portion 318 may be a small display, and the displacement amount of each of the display surfaces 326 may also be very small. The convex lens 312 presents the virtual image of the image displayed on the display surfaces of the display portion 318 to the field of vision of the user.

The object storing portion 12 is a storage area in which data on the virtual object 304 becoming the basis of the AR image which is to be presented to the user of the image presenting apparatus 100 is stored. The data on the virtual object 304, for example, is constituted by three-dimensional voxel data.

The control portion 10 includes an object setting portion 20, a virtual camera setting portion 22, a rendering portion 24, a display control portion 26, a virtual image position determining portion 28, a display surface position determining portion 30, and a position control portion 32.

The object setting portion 20 reads out the voxel data on the virtual object 304 from the object storing portion 12, and sets the virtual object 304 within the virtual space. For example, the virtual object 304 may be disposed in the virtual coordinate system 302 depicted in FIG. 6(a), and the coordinates of the virtual object 304 in the virtual coordinate system 302 may be mapped to the real coordinate system 306 of the real space photographed with the image pickup element 140. The object setting portion 20 may further set a virtual light source for illuminating the virtual object 304 set within the virtual space within the virtual space. It should be noted that the object setting portion 20 may acquire the voxel data on the virtual object 304 from other apparatus located outside the image presenting apparatus 100 through the Wi-Fi module in the chassis 160 by using wireless communication.

The virtual camera setting portion 22 sets the virtual camera 300 for observing the virtual object 304 which the object setting portion 20 sets within the virtual space. The virtual camera 300 may be set within the virtual space so as to correspond to the image pickup element 140 with which the image presenting apparatus 100 is provided. For example, the virtual camera setting portion 22 may change the setting position of the virtual camera 300 in the virtual space in response to the movement of the image pickup element 140.

In this case, the virtual camera setting portion 22 detects a posture and a movement of the image pickup element 140 based on the outputs from the various kinds of sensors such as the electronic compass, the acceleration sensor, and the tilt sensor with which the chassis 160 is provided. The virtual camera setting portion 22 changes the posture and setting position of the virtual camera 300 so as to follow the detected posture and movement of the image pickup element 140. As a result, how to see the virtual object 304 seen from the virtual camera 300 can be changed so as to follow the movement of the head portion of the user mounting thereto the image presenting apparatus 100. As a result, a sense of reality of the AR image which is presented to the user can be more enhanced.

The rendering portion 24 produces the data on the image of the virtual object 304 which the virtual camera 300 set in the virtual space captures. In other words, the rendering portion 24 renders a portion of the virtual object 304 capable of being observed from the virtual camera 300 to produce the image, further in other words, to produce the image of the virtual object 304 in the range seen from the virtual camera 300. The image which the virtual camera 300 captures is a two-dimensional image which is obtained by projecting the virtual object 304 having the three-dimensional information onto the two dimensions.

The display control portion 26 causes the display portion 318 to display thereon the image (for example, the AR image containing the various objects) produced by the rendering portion 24. For example, the display control portion 26 outputs the individual pixel values constituting the image to the display portion 318, and the display portion 318 causes the individual display surfaces 326 to emit the light in the form responding to the individual pixel values.

The virtual image position determining portion 28 acquires the coordinates of the virtual object 304 in either the virtual coordinate system 302 or the real coordinate system 306 from the object setting portion 20. In addition, the virtual image position determining portion 28 acquires the coordinates of the virtual camera 300 in either the real coordinate system 306 or the virtual coordinate system 302 from the virtual camera setting portion 22. The coordinates of the pixels of the image of the virtual object 304 may be contained in the coordinates of the virtual object 304. Alternatively, the virtual image position determining portion 28 may calculate the coordinates of the pixels of the image of the virtual object 304 based on the coordinates exhibiting a specific portion of the virtual object 304.

The virtual image position determining portion 28 identifies the distances from the virtual camera 300 to the pixels of the image of the virtual object 304 in accordance with the coordinates of the virtual camera 300, and the coordinates of the pixels within the image of the virtual object 304. Then, the virtual image position determining portion 28 sets the distances concerned as the presentation positions of the virtual image 316 corresponding to the pixels. In other words, the virtual image position determining portion 28 identifies the distances from the virtual camera 300 to partial areas of the virtual object 304 corresponding to the pixels within the image as the target of the display (hereinafter referred to as “partial areas”). Then, the virtual image position determining portion 28 sets the distances from the virtual camera 300 to the partial areas as the presentation positions of the virtual image 316 of the partial areas.

In such a way, in the second embodiment, the virtual image position determining portion 28 dynamically sets the depth information on the virtual object 304 contained in the image becoming the target of the display in the display portion 318 in accordance with the coordinates of the virtual camera 300, and the coordinates of the pixels of the image of the virtual object 304. As a modified change, similarly to the case of the first embodiment, the depth information on the virtual object 304 may be statically decided in advance, and may be held in the object storing portion 12. In addition, a plurality of pieces of depth information on the virtual object 304 may be decided in advance every combination of the posture and position of the virtual camera 300. In this case, the display surface position determining portion 30 which will be described later may select the depth information corresponding to the combination of the current posture and position of the virtual camera 300.

With respect to the depth information on the virtual object 304, that is, the presentation positions of the virtual images 316 of the pixels within the image as the target of the display, the display surface position determining portion 30 holds a correspondence relationship between the distances from the virtual camera 300 to the partial areas, and the positions, in the Z-axis direction, of the display surface 326 necessary for expressing the distances. The display surface position determining portion 30 determines the positions, in the Z-axis direction, of the plurality of display surfaces 326 of the display portion 318 based on the depth information on the virtual object 304 set by the virtual image position determining portion 28. In other words, the display surface position determining portion 30 determines the positions of the display surfaces 326 corresponding to the pixels in the partial areas of the image as the target of the display.

As described above with reference to FIG. 7, the position of the image 314 and the position of the virtual image 316 present one-to-one correspondence. Therefore, as depicted in Expression (3), the position where the virtual image 316 is presented can be controlled by changing the position of the image 314 corresponding to the virtual image 316. The display surface position determining portion 30 determines the positions of the display surfaces 326 on which the images of the partial areas are to be displayed depending on the distances, from the virtual camera 300 to the partial areas of the virtual object 304, which are determined by the virtual image position determining portion 28. That is to say, the display surface portion determining portion 30 determines the positions of the display surfaces 326 in accordance with the distances from the virtual camera 300 to the partial areas of the virtual object 304, and Expression (3).

Specifically, the display surface position determining portion 30 determines the position of the display surface 326 corresponding to the first pixel, and the position of the display surface 326 corresponding to the second pixel in such a way that the virtual image of the first pixel corresponding to a portion of the visual object 304 to which the distance from the virtual camera 300 is relatively close is presented more forward than the virtual image of the second pixel corresponding to a portion of the visual object 304 from which the distance from the virtual camera 300 is relatively far. More specifically, the display surface position determining portion 30 determines the positions of the display surfaces 326 in such a way that the distance between the display surface 326 corresponding to the first pixel, and the convex lens 312 is made shorter than the distance between the display surface 326 corresponding to the second pixel, and the convex lens 312 is made shorter.

For example, as the distance from the virtual camera 300 to a certain partial area A is farther, the distance from the point 308 of view to the presentation position of the virtual image 316 should be made long. In other words, the virtual image 316 should be seen more backward. Then, the display surface position determining portion 30 determines the position of the display surface 326 corresponding to the pixel of the partial area A in such a way that the distance from the convex lens 312 is made longer. On the other hand, as the distance from the virtual camera 300 to the certain partial area B is closer, the distance from the point 308 of view to the presentation position of the virtual image 316 should be made short. In other words, the virtual image 316 should be seen more forward. Then, the display surface position determining portion 30 determines the position of the display surface 326 corresponding to the pixel of the partial area B in such a way that the distance from the convex lens 312 is made shorter.

In a trial calculation carried out by the present inventor, when a focal length F of the optical element (the convex lens 312 in the second embodiment) for presenting the virtual image 316 is 2 mm, the measurement amount (in the Z-axis direction) of the display surface 326 necessary for presenting the virtual image 316 between the position from a position which is at a distance of 10 cm from the eye surface of the point 308 of view to the infinity is 40 μm. For example, when the operations of the display surfaces 326 are controlled by the piezoelectric actuator, the reference position (initial position) for the display surfaces 326 may be set to a predetermined position (a predetermined distance from the convex lens 312) necessary for expressing the infinity. Then, the position which is located forward at a distance of 40 μm from the front in the Z-axis direction may be set as a position (closest position), where the display surfaces 326 are closest to the convex lens 312, for expressing the position located at a distance of 10 cm from the front of the eye. In this case, the display surface 326 corresponding to the pixel in the partial area which should be seen to the infinity does not need to be moved.

In addition, when the operations of the display surfaces 326 are controlled by the electrostatic actuator, the reference position (initial position) for the display surfaces 326 may be set to a predetermined position (a predetermined distance from the convex lens 312) necessary for expressing the position located at a distance of 10 cm from the front of the eyes. Then, the position located at a distance of 40 μm behind in the Z-axis direction may be set as the position (farthest position) where the display surfaces 326 are located farthest from the convex lens 312, for expressing the infinity. In this case, the display surface 326 corresponding to the pixel in the partial area which should be seen in a position located at a distance of 10 cm from the front of the eyes does not need to be moved. In such a way, when the focal length F of the optical element for presenting the virtual image 316 is 2 mm, the display surface position determining portion 30 may determine the positions, in the Z-axis direction, of the plurality of display surfaces 326 in the range of 40 μm.

The position control portion 32 outputs a predetermined signal in accordance with which the MEMS actuator for driving the display surfaces 326 is controlled to the display portion 318 similarly to the case of the first embodiment. Information exhibiting the positions, in the Z-axis direction, of the display surfaces 326 which are determined by the display surface position determining portion 30 is contained in this signal.

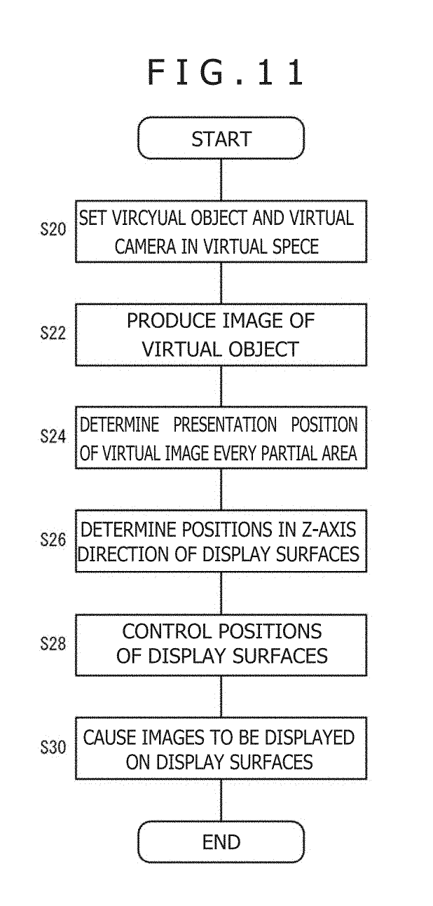

A description will now be given with respect to an operation of the image presenting apparatus 100 configured in the manner described above. FIG. 11 is a flow chart depicting an operation of the image presenting apparatus 100 of the second embodiment. The pieces of processing depicted in the figure may be started when a power source of the image presenting apparatus 100 is activated. In addition, the processing of S20 to S30 in the figure may be repeated in accordance with the newest position and posture of the image presenting apparatus 100 at the refresh rate (for example, 120 Hz) which is determined in advance. In this case, the AR image (may be the VR image) presented to the user is updated at the refresh rate.

The object setting portion 20 sets the virtual object 304 in the virtual space, and the virtual camera setting portion 22 sets the virtual camera 300 in the virtual space (S20). The real space imaged by the image pickup element 140 of the image presenting apparatus 100 may be taken in as the virtual space. The rendering portion 24 produces the image of the virtual object 304 in the range seen from the virtual camera 300 (S22). The virtual image position determining portion 28 determines the presentation position of the virtual image of the partial area every partial area of the image becoming the target of the display in the display portion 318 (S24). In other words, the virtual image position determining portion 28 determines the distance from the point 308 of view to the virtual image of the pixels in units of a pixel of the image as the target of the display. For example, the virtual image position determining portion 28 determines that distance in the range of the position located at a distance of 10 cm before the eyes to the infinity.

The display surface position determining portion 30 determines the positions, in the Z-axis direction, of the display surfaces 326 corresponding to the pixels in accordance with the presentation positions, of the virtual images in the pixels, which are determined by the virtual image position determining portion 28 (S26). For example, when the focal length F of the convex lens 312 is 2 mm, the display surface position determining portion 30 determines the positions in the range of +40 μm in the front of the reference position. Although not illustrated, the processing of S22, and the two pieces of processing of S24 and S26 may be executed in parallel with each other. As a result, the display speed of the AR image can be accelerated.

The position control portion 32 adjusts the positions, in the Z-axis direction, of the display surfaces 326 in the display portion 318 in accordance with the determination by the display surface position determining portion 30 (S28). When the position adjustment for the display surfaces 326 has been completed, the position control portion 32 instructs the display control portion 26 to carry out the display, and the display control portion 26 causes the display portion 318 to display thereon the image produced by the rendering portion 24 (S30). The display portion 318 causes the display surfaces 326 to emit the light in a form corresponding to the pixel values. As a result, the display portion 318 causes the display surfaces 326 in which the positions in the Z-axis direction have been adjusted to display thereon the partial areas of the image.

The image presenting apparatus 100 of the second embodiment, displaces the display surfaces 326 provided in the display portion 318 to the direction of the line of sight of the user, thereby reflecting the depth of the virtual object 304 on the virtual image presentation positions of the pixels depicting the virtual object 304. As a result, the more stereoscopic AR image can be presented to the user. In addition, even in the case of one eye, the user seeing the image can be made to inspire the stereoscopic effect. The reason for this is because the information, in the depth direction, on the virtual object 304 is reflected on the presented positions of the virtual images 316 in the pixels, that is, the information in the direction of the ray which the light has is reproduced.

In addition, in the image presenting apparatus 100, the depth of the virtual object 304 can be expressed steplessly in the range of the short distance to the infinity in units of a pixel. As a result, the image presenting apparatus 100 can present the image having the high depth resolution, and the resolution is prevented from being injured.

In addition, the image presenting technique by the image presenting apparatus 100 is especially effective in the optical transmission type HMD. The reason for this is because the information, in the depth direction, on the virtual object 304 is reflected on the virtual image 316 of the virtual object 304, and thus the user can be made to perceive the virtual object 304 as if the virtual object 304 is the object in the real space. In other words, when the object in the real space, and the virtual object 304 are mixedly present in the field of vision of the user of the optical transmission type HMD, the both can be seen in harmony without a sense of discomfort.

### Third Embodiment

An image presenting apparatus 100 of a third embodiment is also an HMD to which a device (the display portion 318) which is displaced in the Z-axis direction is applied. The HMD of the third embodiment displaces the surface of the screen which does not emit the light in itself in units of a pixel, and projects the image on the screen. Since the individual display surfaces 326 of the display portion 318 do not need to emit the light, the limitation of the wirings and the like in the display portion 318 becomes small, and the easiness of the mounting is enhanced. In addition, the cost of the product can be suppressed. Hereinafter, the same or corresponding members as or to those which were described in the first or second embodiment are assigned the same reference numerals. The description overlapping that of the first or second embodiment is suitably omitted.

FIG. 12 schematically depicts an optical system with which the image presenting apparatus 100 of the third embodiment is provided. The image presenting apparatus 100 of the third embodiment is provided with a convex lens 312, a display portion 318, a projection portion 320, a reflection member 322, and a reflection member 324 within the chassis 160 of the HMD depicted in FIG. 5. The projection portion 320 projects a laser beam exhibiting an image on which various kinds of objects are caught. The display portion 318 is a screen which diffusely reflects a laser beam projected by the projection portion 320 to display thereon the image to be presented to the user. The reflection member 322 and the reflection member 324 are each an optical element (for example, a mirror) for totally reflecting the incident light.

In the optical system depicted in FIG. 12, the laser beam projected by the projection portion 320 is totally reflected by the reflection member 322 to reach the display portion 318. The light of the image displayed on the display portion 318, in other words, the light of the image diffusely reflected on the surface of the display portion 318 is totally reflected by the reflection member 324 to reach the eyes of the user.

In the third embodiment, a left side surface of the display portion 318 depicted in FIG. 2 becomes a surface on which the laser beam from the projection portion 320 is projected (hereinafter referred to as “a projection surface”). The projection surface can be said as a surface confronting the user (the point 308 of view of the user), and can also be said as a surface orthogonally intersecting the direction of the line of sight of the user. The display portion 318 includes the plurality of display surfaces 326 corresponding to a plurality of pixels within the image as the target of the display on the projection surface thereof. In other words, the projection surface of the display portion 318 is constituted by the plurality of display surfaces 326.

In the third embodiment, the pixels within the image displayed on the display portion 318 (projection surface), and the display surfaces 326 present one-to-one-correspondence. That is to say, the display portion 318 (projection surface) is provided with the display surfaces 326 for the number of pixels of the image to be displayed. In the third embodiment, the light from the pixels of the image projected on the display portion 318 is totally reflected by the display surfaces 326 corresponding to the pixels. The display portion 318 in the third embodiment changes the positions, in the Z-axis direction, of the individual display surfaces 326 independently of one another by the micro-actuator similarly to the case of the second embodiment.

Similarly to the case of FIG. 8, in FIG. 12 as well, the Z-axis is decided in the direction of the line of sight of the point 308 of view. Thus, the convex lens 312 is disposed in such a way that the optical axis of the convex lens 312 and the Z-axis agree with each other on the Z-axis. The focal length of the convex lens 312 is F, and in FIG. 12, two points F represents the focal points of the convex lens 312. As depicted in FIG. 12, the display portion 318 is disposed on the inner side of the focal point of the convex lens 312 on the side opposite to the point 308 of view with respect to the convex lens 312.

The principle in which the optical system in the third embodiment changes the presentation position of the virtual image to the user every pixel is similar to that in the second embodiment. That is to say, the positions of the display surfaces 326, in the Z-axis direction, of the display portion 318 are changed, so that the virtual images of the image (pixels) which the display surfaces 326 display is observed in the different positions. In addition, the image presenting apparatus 100 of the third embodiment is an optical transmission type HMD which transparently brings the visible light from the outside of the apparatus (from the front of the user) to the eyes of the user similarly to the case of the second embodiment. Therefore, the eyes of the user observe a state in which the situation (for example, the object in the real space) of the real space of the outside of the apparatus, and the virtual image (for example, the virtual image of the AR image including the virtual object 304) of the image which the display portion 318 displays are superimposed on each other.

The functional configuration of the image presenting apparatus 100 of the third embodiment is similar to that of the second embodiment (FIG. 10). However, the image presenting apparatus 100 of the third embodiment is different from the image presenting apparatus 100 of the second embodiment in that the image presenting portion 14 further includes the projection portion 320, and the destination of the output of the signal from the display control portion 26 becomes the projection portion 320.

The projection portion 320 projects the laser beam for causing the image to be presented to the user to be displayed onto the display portion 318. The display control portion 26 causes the display portion 318 to display thereon the image produced by the rendering portion 24 by controlling the projection portion 320. Specifically, the display control portion 26 outputs the image data (for example, the pixel values of the image to be displayed on the display portion 318) produced by the rendering portion 24 to the projection portion 320, and causes the projection portion 320 to output the laser beam exhibiting the image concerned.

An operation of the image presenting apparatus 100 of the third embodiment is also similar to that in the second embodiment (FIG. 11). The position control portion 32 adjusts the positions in the Z-axis direction of the display surfaces 326 in the display portion 318 in accordance with the determination by the display surface position determining portion 30 (S28). When the position adjustment for the display surfaces 326 has been completed, the position control portion 32 instructs the display control portion 26 to carry out the display. The display control portion 26 outputs the pixel values of the image produced by the rendering portion 24 to the projection portion 320, and the projection portion 320 projects the laser beams corresponding to the pixel values onto the display portion 318. As a result, the display portion 318 causes the display surfaces 326 in which the positions in the Z-axis direction have been adjusted to display thereon the partial areas of the image (S30).

The image presenting apparatus 100 of the third embodiment can also reflect the depth of the virtual object 304 on the virtual image presentation positions of the pixels exhibiting the virtual object 304 similarly to the case of the image presenting apparatus 100 of the second embodiment. As a result, the more stereoscopic AR image or VR image can be presented to the user.

The present invention has been described so far based on the first to third embodiments. It is understood by a person skilled in the art that the embodiments are exemplifications, various modified changes can be made for a combination of the constituent elements and processing processes in the embodiments, and such modified changes also fall within the scope of the present invention. Hereinafter, the modified changes will be depicted.

A first modified change will now be described. There may be adopted a configuration in which an external information processing apparatus of the image presenting apparatus 100 (a game machine in this case) is provided at least a part of the functional blocks of the control portion 10, the image storing portion 16, and the object storing portion 12 which are depicted in FIG. 3 and FIG. 10. For example, the game machine may execute an application of a game or the like which presents a predetermined image (AR image or the like) to the user, and may include the object storing portion 12, the object setting portion 20, the virtual camera setting portion 22, the rendering portion 24, the virtual image position determining portion 28, and the display surface position determining portion 30.

The image presenting apparatus 100 of the first modified change may be provided with a communication portion, and may transmit the data which the image pickup element 140 and the various kinds of sensors acquire to the game machine through the communication portion. The game machine may produce the data on the image to be displayed by the image presenting apparatus 100, and may determine the positions, in the Z-axis direction, of the plurality of display surfaces 326 of the image presenting apparatus 100, thereby transmitting these pieces of data to the image presenting apparatus 100. The position control portion 32 of the image presenting apparatus 100 may output the information on the positions of the display surfaces 326 which is received by the communication portion to the display portion 318. The display control portion 26 of the image presenting apparatus 100 may output the image data received by the communication portion to either the display portion 318 or the projection portion 320.

In the first modified change as well, the depths of the objects (the virtual objects 304 or the like) contained in the image can be reflected on the virtual image presentation positions of the pixels exhibiting the objects. As a result, the more stereoscopic image (AR image) can be presented to the user. In addition, the rendering processing, the virtual image position determining processing, the display surface position determining processing, and the like are executed by an external resource of the image presenting apparatus 100, thereby enabling the hardware resource necessary for the image presenting apparatus 100 to be reduced.

A second modified change will now be described. In the embodiments described above, the display surfaces 326 which are driven independently of one another are provided by the number of pixels of the image as the target of the display. As a modified change, there may be adopted a configuration in which the images of N (N is an integer number of two or more) pixels are collectively displayed on a display surface 326. In this case, the display portion 318 includes (the number of pixels within the image as the target of the display/N) display surfaces 326. The display surface position determining portion 30 may determine the positions of a certain display surface 326 based on an average of the distances between a plurality of pixels to which the certain display surface 326 corresponds, and the camera. In addition, the display surface position determining portion 30 may determine the position of a certain display surface 326 based on the distance between one of a plurality of pixels to which the certain display surface 326 corresponds (for example, a central or approximately central pixel of a plurality of pixels), and the camera. In this case, the control portion 10, in units of a plurality of pixels, adjusts the positions of the display surfaces 326 in the Z-axis direction corresponding to these pixels.

An arbitrary combination of the embodiments described above and the modified changes thereof is also useful as an embodiment of the present invention. A new embodiment(s) produced by the combination(s) has(have) both the effects of the embodiments and the modified changes thereof. In addition, it is also understood by a person skilled in the art that the function(s) which the constituent requirements described in claims should play are realized by either the single element or the cooperation of the constituent elements depicted in the embodiments and the modified changes thereof.

### REFERENCE SIGNS LIST

10 . . . Control portion, 20 . . . Object setting portion, 22 . . . Virtual camera setting portion, 24 . . . Rendering portion, 26 . . . Display control portion, 28 . . . Virtual image position determining portion, 30 . . . Display surface position determining portion, 32 . . . Position control portion, 100 . . . Image presenting apparatus, 312 . . . Convex lens, 318 . . . Display portion, 326 . . . Display surface

### INDUSTRIAL APPLICABILITY

This invention can be utilized in an apparatus for presenting an image to a user.

1. An image presenting apparatus, comprising:
a display portion configured to display an image; and
a control portion,
wherein the display portion includes a plurality of display surfaces corresponding to a plurality of pixels within an image as a target of display, and the display surfaces are configured to be changeable in positions in a direction vertical to the display surfaces, and
the control portion adjusts positions of the plurality of display surfaces based on depth information on an object contained in the image as the target of the display.

2. The image presenting apparatus according to claim 1, wherein the depth information on the object contains a distance from a camera for imaging the object to the object, and
the control portion carries out adjustment in such a way that with respect to a first pixel corresponding to a portion of the object to which a distance from the camera is close, and a second pixel corresponding to a portion of the object to which a distance from the camera is far, a position of the display surface corresponding to the first pixel is located more forward than a position of the display surface corresponding to the second pixel.

3. An image presenting apparatus, comprising:
a display portion configured to display an image;
an optical element for presenting a virtual image of the image displayed on the display portion to a field of vision of a user; and
a control portion,
wherein the display portion includes a plurality of display surfaces corresponding to a plurality of pixels within an image as a target of display, and the display surfaces are configured to be changeable in positions in a direction vertical to the display surfaces, and
the control portion adjusts positions of the plurality of display surfaces based on depth information on an object contained in the image as the target of the display, thereby adjusting a position of a virtual image presented by the optical element in units of a pixel.

4. The image presenting apparatus according to claim 3, wherein the depth information on the object contains a distance from a camera for imaging the object to the object, and
with respect to a first pixel corresponding to a portion of the object to which a distance from the camera is close, and a second pixel corresponding to a portion of the object from which a distance from the camera is far, the control portion makes a distance between the display surface corresponding to the first pixel and the optical element shorter than a distance between the display surface corresponding to the second pixel and the optical element.

5. The image presenting apparatus according to claim 3, wherein the depth information on the object contains a distance from a camera for imaging the object to the object, and
the control portion adjusts a position of the display surface corresponding to at least one of the first pixel and the second pixel in such a way that the virtual image of the first pixel corresponding to a portion of the object to which the distance from the camera is close is presented more forward than the virtual image of the second pixel corresponding to a portion of the object from which the distance from the camera is far.

6. The image presenting apparatus according to claim 3, wherein the display portion includes a micro electro mechanical system.

7. An optical transmission type head-mounted display comprising:
an image presenting apparatus, including
a display portion configured to display an image;
an optical element for presenting a virtual image of the image displayed on the display portion to a field of vision of a user, and
a control portion,
wherein the display portion includes a plurality of display surfaces corresponding to a plurality of pixels within an image as a target of display, and the display surfaces are configured to be changeable in positions in a direction vertical to the display surfaces, and
the control portion adjusts positions of the plurality of display surfaces based on depth information on an object contained in the image as the target of the display, thereby adjusting a position of a virtual image presented by the optical element in units of a pixel.

8. A method which an image presenting apparatus provided with a display portion carries out, the display portion including a plurality of display surfaces corresponding to a plurality of pixels within an image as a target of display, and the display surfaces being configured to be changeable in positions in a direction vertical to the display surfaces, the method comprising:
adjusting positions of the plurality of display surfaces based on depth information on an object contained in the image as the target of the display; and
causing the display portion in which the positions of the display surfaces are adjusted to display thereon the image as the target of the display.

9. A method which an image presenting apparatus provided with a display portion and an optical element carries out,
the display portion including a plurality of display surfaces corresponding to a plurality of pixels within an image as a target of display, and the display surfaces being configured to be changeable in positions in a direction vertical to the display surfaces, the method comprising:
adjusting positions of the plurality of display surfaces based on depth information on an object contained in the image as the target of the display, the optical element serving to present a virtual image displayed on the display portion to a field of vision of a user; and
causing the display portion in which the positions of the display surfaces are adjusted to display thereon the image as the target of the display, thereby presenting the virtual images of the pixels within the image to a position based on the depth information through the optical element.
